(19) United States
(12) Patent Application Publication
(10) Pub. No.: US 2005/0021852 A1
(43) Pub. Date: Jan. 27, 2005

(54) Gateway and method for the interconnection of two networks, especially a HAVi network and an UPnP network

(75) Inventors: Jean-Paul Accarie, Vern-Sur-Seiche (FR); Patrice Nezou, Chartres De Bretagne (FR)

Correspondence Address: FITZPATRICK CELLA HARPER & SCINTO, 30 ROCKEFELLER PLAZA, NEW YORK, NY, 10112, US

(73) Assignees: CANON RESEARCH CENTRE FRANCE S.A., Cesson Sevigne (FR); CANON EUROPA NV, Amstelveen (NL)

(21) Appl. No.: 10/724,701

(22) Filed: Dec. 2, 2003

(30) Foreign Application Priority Data
Dec. 3, 2002 (FR) 02 15240

(51) Int. Cl. G06F 15/16; G06F 15/173

(52) U.S. Cl. 709/245; 709/223

(57) ABSTRACT

A method of interconnection, through a gateway, between a first network of type IEEE 1394 enabling communications between a plurality of HAVi compliant devices and a second network enabling communications between a plurality of devices comprising the steps of: determining a global unique identifier for each device from the second network; determining a distinct IEEE 1394 address for each device from the second network; representing each device from the second network by a HAVI compliant software element hosted by the gateway; managing communication between devices from the first network and devices from the second network, using for each device from the second network, its corresponding software element associated with the global unique identifier and the IEEE1394 address.

### BACKGROUND OF THE INVENTION

1. Field of the Invention

The field of the invention is that of gateways for the interconnection of networks, each enabling communications between a plurality of devices.

More specifically, the invention relates to a gateway for the interconnection of a first network of a first type enabling communications between a plurality of devices compliant with a first standard of interoperability between devices, and a second network of a second type enabling communications between a plurality of devices compliant with a second standard of interoperability between devices.

It is assumed that the second type of network is different from the first type of network. The second standard of interoperability between devices may be either identical to or different from the first standard of interoperability between devices.

The situation, which consists of having both networks of the same type, is also possible. In general, a gateway possesses functions that enable especially the devices of the first network to be made visible to the second network or that enable communications to be set up between several devices belonging to a same network or to different networks and enable the transfer of (asynchronous or isochronous) data between the two networks, etc.

The present invention is aimed at resolving the specific problems identified with respect to the first network (typically a 1394 network using HAVI as a standard of interoperability between devices in the specific context below) of the gateway. In other words, the invention describes a technique to make the devices of the second network visible in the first network.

Typically, the first and second networks are home audiovisual networks, used for communications between analog and/or digital type audio and/or video devices, so that they can exchange audiovisual signals.

The devices belong for example to the following (non-exhaustive) list: television receivers (using satellite, RF channels, cable, xDSL and other means), television sets, video cassette recorders, scanners, digital camcorders, digital cameras, DVD readers, computers, personal digital assistants (PDAs), printers, etc.

The invention can be applied especially, but not exclusively, in the special context where the first network is a bus according to the IEEE 1394 standard, to which HAVi compliant devices are connected, and the second network is an IP (Internet-protocol based) network to which the UPnP standard compliant devices are connected.

The IEEE 1394 standard is described in the following reference documents: “IEEE Std 1394-1995, Standard for High Performance Serial Bus” and “IEEE Std 1394a-2000, Standard for High Performance Serial Bus (Supplement)”.

The HAVi standard is described in the reference document “HAVi (Home Audio Video interoperability) specifications (version 1.1 May 15, 2001)”.

The UPnP standard is described in the reference document “UPnP (Universal Plug and Play) architecture specification (version 1.0 Jun. 8, 2000)”.

2. Description of the Prior Art

For the sake of simplicity, the drawbacks of the prior art shall be described with reference to the particular context mentioned here above (IEEE1394-HAVi/IP-UPnP). It is clear however the present invention is not limited to this particular combination of standards.

It may be recalled that the standards of interoperability between devices, especially the HAVi and UpnP standards, each define an intermediate software layer (known as the Middleware layer) providing the interface between, firstly, a set of lower layers, especially the communications and transport layers and, secondly, a set of higher application layers. In other words, each of these standards gives standardized services and functions (for example an Applications Programming Interface or API) on which services can be developed, independently of the implementation of the networks.

The HAVi and UPnP result from two initiatives by industry, designed to meet different needs. According to present trends, the HAVi is considered to be suited to audiovisual devices connected to an IEEE 1394 bus, and the UPnP is suited to audiovisual equipment connected to an IP network. Now, it is desired that both these types of devices (“HAVi” devices and “UPnP devices”) should be present in a home audiovisual network. The question of the coexistence of the HAVi and UPnP standards therefore needs to be addressed.

Referring to FIGS. 1 and 2, we shall now recall some characteristics defined in the HAVi standard.

FIG. 1 shows an example of the hardware architecture of a HAVi device. This hardware architecture conventionally comprises: a bus 200 to interconnect the elements listed here below; a central processing unit (CPU) 201, a clock 202, an internal system 203, a keyboard 204, a RAM type memory 205, a ROM type memory 206, an input/output system 207, a display means (screen) 208 and a network adaptor 209.

FIG. 2 shows an example of the software architecture of a HAVi device. This software architecture, stored in the ROM type memory 206 and implemented in the RAM type memory 205 (see FIG. 1) of the HAVi device, comprises:
a set 210 of lower layers, especially communications and transport layers, forming a “vendor-specific” platform (namely a platform specific to the manufacturer of the device) 215 connected to the IEEE 1394 type digital bus 216;
a set 211 of higher application layers, comprising application modules (AM) 213 and “Havlet” modules 214;
an intermediate layer (“HAVi stack”) 212, providing the interface between the set 210 of lower layers and the set 211 of higher layers.

The HAVi stack 212 itself comprises:
a 1394 communications media manager (1394 CMM) 217, responsible for IEEE 1394 type communications aspects;
a messaging system 218, by which all the other modules of the HAVi stack can communicate;
a registry (or registry management module) 219;
an event manager (or event management module) 220;
a stream manager, SM (or stream management module) 221, used to set up a stream connection between two devices;
a resource manager (or resource management module) 222;
a device control module (DCM) manager or management module 223;
device control modules (DCM) 224 and function control modules (FCM) (not shown), each used to control one HAVi device. The function control modules (FCM) are “sub-modules” of the device control modules (DCM).

According to the HAVi terminology, all the above-mentioned modules (213, 214, 219 to 224), which are hosted by the devices, are called software elements (SE).

Four types of HAVi devices can be distinguished, depending on the modules that they implement (especially among those listed here above). These four types of HAVi devices can be grouped under two categories:
FAV (“Full AudioVideo”) devices and IAV (<<Intermediate AudioVideo>>) devices which are “intelligent” devices as understood in the HAVi standard (that is, devices capable of controlling other devices);
BAV (<<Base AudioVideo>>) and LAV (<<Legacy AudioVideo >>) devices, which are “non-intelligent” devices as understood in the HAVi standard (that is, devices controlled by other devices).

It is also important to recall that the HAVi (version 1.1) defines an essential concept of the HAVi Unique Identifier (or HUID). According to this concept, certain software elements, namely application modules (AM), device control modules (DCM) and function control modules (FCM), possess one HUID each. This HUID comprises especially an important field, called “TargetId”, itself comprising especially a “type” sub-field and a “GUID” sub-field.

The “type” sub-field indicates whether the software element concerned is an application module (AM), a device control module (DCM) or a function control module (FCM). In the latter two cases, this sub-field also indicates whether the controlled device is IEC 61883 compatible (namely, if IEC 61883 registers are physically located therein).

The “GUID” sub-field indicates the Global Unique Identifier (or GUID) of the device to be used for the IEEE 1394 communications with the software element concerned. The following cases can be distinguished:
if the software element concerned is a device control module (DCM) or a function control module (FCM), and if the controlled device is IEC 61883 compatible, the GUID identifier indicated is that of the controlled device;
if the software element concerned is a device control module (DCM) or a function control module (FCM), and the controlled device is not IEC 61883 compatible, the GUID indicated is that of the “host” of the software element concerned;
if the software element concerned is an application module (AM), the GUID identifier indicated is that of the “host” device that hosts the software element concerned.

It will be noted that, in the HAVi standard, the following one-to-one relationships are defined:
(i) each device has only one corresponding GUID identifier;
(ii) each device has only one corresponding 1394 addresses.

FIG. 3 shows a possible use of a prior art gateway 1 in the particular context mentioned here above.

The first network 2 is a bus according to the IEEE 1394 standard. In this example, two HAVi devices are connected thereto: one, referenced A is a HAVi BAV device (for example a digital video recorder (DVCR)) or LAV (for example are digital camcorder) and the other, referenced C, is a HAVi IAV device (for example a Set-Top-Box (STB, or satellite receiver/tuner or cable)) or FAV (for example a digital television (DTV)).

The device C hosts (namely “executes”) a stream management module (SM) referenced 5, as well as the control module (DCM) for the device A. This control module, the referenced 4, is symbolized in FIG. 3 by a circle containing the letter A.

It will be noted that the HAVi can “store” the program of one or more device control modules (DCM), without the activation of these programs. After the activation of this program or these programs for their execution, it is assumed that the device considered will “host” the associated device control module (DCM).

It will be also noted that, for the sake of simplicity, it is only the case of device control modules (DCM) that is discussed here. However, it is clear that this discussion can also be directly transposed to function control modules (FCM).

The second network 3 is an IP network. In this example, two UpnP devices are connected thereto: one of them, referenced B, is a controlled device (UPnP Controlled Device) and the other referenced D, is the device capable of controlling (UPnP Control Point) the other devices. In this example, it is assumed that the two UPnP devices, referenced B and D, may be implicated in a stream connection. For example, the device B is a “webcam” capable of generating a video data stream, and the device D is a personal computer (PC) capable of rendering the video data stream.

After they have been detected on the IP network 3 side, the devices B and D are represented on the HAVi side of the gateway 1 by two device control modules (DCM). These modules, referenced 6 and 7 respectively, are symbolized in FIG. 3 by circles containing the letters B and D respectively.

It is now assumed that the stream management module (SM) hosted by the device C wishes to set up a stream connection between the device A (as a receiver device) and the device B (as a emitting device). This implies that the stream management module (SM):
transmits 1394 packets (asynchronous packets) to IEC 61883 registers physically located in the device A and in the gateway 1 responsible for the management of the “remote” device B (remote because it is not directly accessible as it is connected to the IP network). The IEC 61883 standard is described in the referenced document “IEC 61883 Parts 1-5 Standard for a Consumer-Use Digital Interface”). In FIG. 3, the registers of the device A are referenced a1 and those of the gateway 1 are referenced g1, g2, etc.;
exchanges HAVi messages with the device control module (DCM) 4 of the device A, which is hosted by the device C, and with the control module (DCM) 6 of the device B, which is hosted by the gateway 1. These HAVi messages are packaged in 1394 packets

The prior art gateway 1 shown briefly here above with reference to FIG. 3 has several drawbacks.

First of all, it is not compatible with the concept of a HAVi unique identifier (HUID), since the one-to-one relationship (i) mentioned here above (each device has only one GUID identifier corresponding to it) is not complied with. Indeed, it is impossible to define a different HUID for each of the DCM, FCM and AM modules hosted by the gateway, since they all possess the GUID identifier of the gateway (as devices to be used for the IEEE 1394 communications with these modules) in the “GUID” sub-field of the “TargetId” field of their HUID identifier.

Other drawbacks arise out of the fact that the one-to-one relationship (ii) mentioned here above (each device has only one corresponding 1394 address) is not complied with either. Indeed, the fact that the gateway manages the UPnP device means that all these devices have the gateway 1394 address as their 1394 addresses.

The processing of the HAVi messages intended for the DCM, FCM and AM modules hosted by the gateway is complex, because all these HAVi messages are packaged in 1394 packets whose destination address is the 1394 address of the gateway. The gateway must therefore implement a specific mechanism for the processing of 1394 packets, that it receives in order to:
detect any HAVi messages that may be packaged therein;
within each HAVi message detected, identify the destination module among the DCM, FCM and AM modules that it hosts;
give each detected HAVi message to the identified destination module.

Furthermore, the fact that the 1394 address of the gateway is used for all the UPnP devices implies that all the IEC 61883 registers associated with the UPnP devices and intended to receive 1394 packets (especially in the context of stream connection) are physically located in the gateway (since they cannot be located in the UPnP devices).

Now the gateway, as a 1394 device, has a limited number of IEC 61883 registers: 31 at input (iPCR, for “input Control Register”) and 31 at output (oPCR, for “output Control Register”). These registers therefore have to be shared between all the UPnP devices located in the second network. This is therefore a constraint on the maximum number of devices of the second network that can be managed by the gateway.

The fact of having to physically implement the registers IEC 61883 on the gateway also entails the drawback of unnecessarily using up bandwidth in certain situations. Let us take the example in which an isochronous data stream is set up by a device C located in the first network between the devices B and D located in the second network. After the gathering of information on the types of formats and transmission, the device C writes in the register iPCR of the stream-receiving device B and the register oPCR of the stream-sending device D. Since the registers iPCR and oPCR are physically implemented in the gateway (these registers can also be read by the other devices on the bus 1394), the isochronous data stream must be delivered on the bus 1394, and this will be done unnecessarily.

It is an object of the invention especially to overcome these different drawbacks of the prior art.

### SUMMARY OF THE INVENTION

More specifically, one of the goals of the present invention is to provide a gateway by which, in the first network, all the devices of the second network can be made visible while, at the same time, each device of the second network is able to possess a global unique identifier.

In the case of a first HAVi network, it is a goal of the invention to thus extend the notion of HAVi unique identifier (HUID) to the DCM, FCM and AM modules hosted by the gateway and pertaining to the devices of the second network (not HAVi).

It is also a goal of the invention to provide a gateway that can be used to simplify the processing of messages received by the gateway and intended for different software elements (DCM, FCM and AM according to the HAVi terminology) pertaining to devices of the second network.

Another goal of the invention is to provide a gateway that does not necessitate a physical localization, in the gateway, of all the registers (typically the IEC 61883 registers) associated with the devices of the second network and designed to receive packets (typically 1394 packets) (especially in the context of stream connections).

It is an additional goal of the invention to provide a gateway enabling the optimizing of the bandwidth consumption.

These different goals and others that shall appear hereinafter are achieved according to the invention by means of a gateway enabling the interconnection of a first network of type IEEE 1394 enabling communications between a plurality of HAVi compliant devices and a second network enabling communications between a plurality of devices, wherein the gateway comprises:
means to determine a global unique identifier for each device from the second network;
means to determine a distinct IEEE 1394 address for each device from the second network;
means to represent each device from the second network by a HAVI compliant software element hosted by the gateway;
means to manage communication between devices from the first network and devices from the second network, using for each device from the second network, its corresponding software element associated with the global unique identifier and the IEEE1394 address.

The general principle of the invention therefore consists of ensuring that the two above-mentioned one-to-one relationships (i) and (ii) are verified for the devices of the second network when they are seen by the first network.

The gateway according to the invention enables the first network to see each device of the second network by means of a virtual device that is associated with it and that possesses a global unique identifier (the one assigned to this device of the second network) and a unique address (on a virtual network, managed in the gateway, which is an image of the second network but possesses the same structure as the first network).

The invention advantageously relies on the specifications of the 1394.1 standard, and the bridge therefore is not specifically developed herein. The 1394.1 is described in the reference document “P1394.1 Draft Standard for High Performance Serial Bus Bridges (Draft 1.03, Aug. 26, 2002)”.

Advantageously, the gateway comprises means for the management of virtual registers associated with virtual devices representing devices of the second network compliant with a standard on the management of registers.

Thus, the registers associated with the devices of the second network, and intended to receive packets, are virtual registers managed by the gateway and not by registers physically present on the gateway. This removes any constraints on the maximum number of devices of the second network that can be managed by the gateway. Furthermore, this optimizes the bandwidth consumption (see discussion here above).

Advantageously, the standard pertaining to the management of registers is the IEC 61883 standard.

In a particular embodiment of the invention, the second network is an IP network based on the Internet protocol. The second network sets up communications between a plurality of devices compliant with a second standard of interoperability between devices, for example the UPnP standard.

Alternatively, the second network is a IEEE 1394 network enabling communications between a plurality of HAVI compliant devices.

According to an advantageous characteristic, the means by which the means emulating the second portal communicate with the devices of the second network furthermore comprise:
means responsible for adaptive interfacing processing between the first and second standards of interoperability between devices;
means required in all devices compliant with the second standard of interoperability between devices.

The invention also relates to a method of interconnection, through a gateway, between a first network of type IEEE 1394 enabling communications between a plurality of HAVi compliant devices and a second network enabling communications between a plurality of devices comprising the steps of:
determining a global unique identifier for each device from the second network;
determining a distinct IEEE 1394 address for each device from the second network;
representing each device from the second network by a HAVI compliant software element hosted by the gateway;
managing communication between devices from the first network and devices from the second network, using for each device from the second network, its corresponding software element associated with the global unique identifier and the IEEE1394 address.

The invention also relates to a computer program product comprising instruction sequences adapted to the implementation of a method as referred to here above when said program is executed on a computer.

### BRIEF DESCRIPTION OF THE DRAWINGS

Other features and advantages of the invention shall appear from the following description of the preferred embodiment of the invention, given by way of non-restrictive illustration, and from the appended drawings, of which:

FIG. 1, already described here above in the document, shows an example of a hardware architecture of a HAVi device;

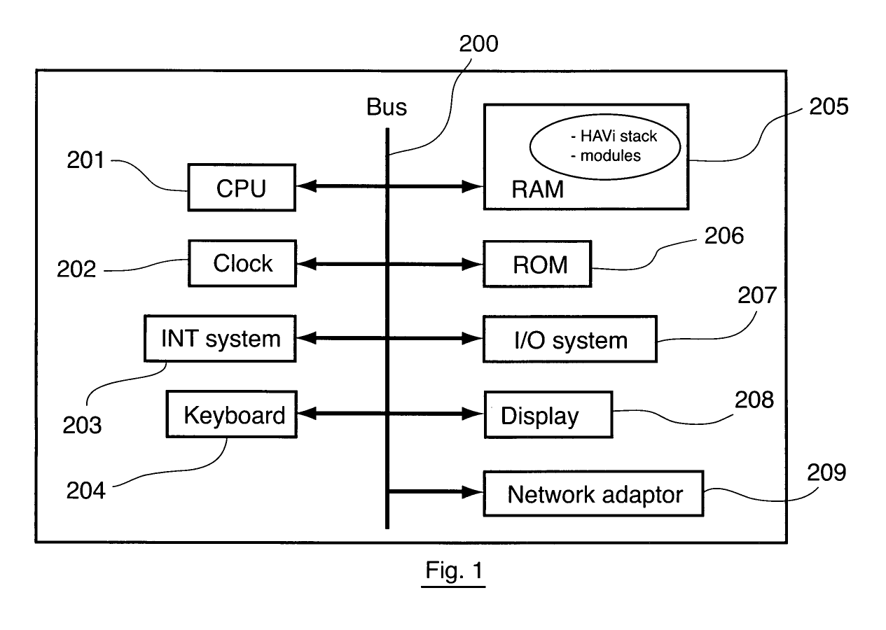

FIG. 2, also described here above, illustrates an example of the software architecture of a HAVi device;

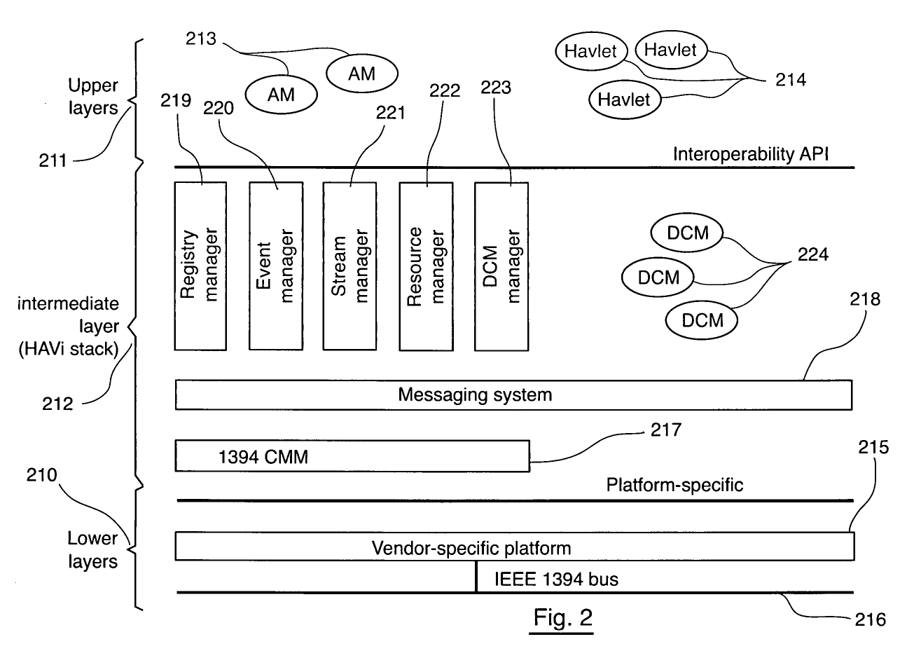

FIG. 3, also described here above, shows a gateway connecting a HAVi network and a UPnP network according to the prior art;

FIG. 4 shows a gateway connecting a HAVi network and a UPnP network according to the invention;

FIG. 5 shows a particular embodiment of the software architecture of the gateway according to the invention, appearing in FIG. 4;

FIG. 6 shows an example of a table of correspondence between the HAVi and UPnP elements at the gateway according to the invention;

FIG. 7 shows an example of the allocation of GUID identifiers and 1394 type addresses for emulated devices on the HAVi side of the gateway according to the invention;

FIG. 8 is a flow chart of an example of software processing operation for the management of topology changes if any;

FIG. 9 is a flow chart of an example of software processing operation for the management of 1394.1 inter-bridge messages.

### MORE DETAILED DESCRIPTION

The invention therefore relates to a gateway for the interconnection of two networks enabling each of them to carry out communications between a plurality of devices.

Hereinafter in the description, we consider the particular case in which the first network 2 is an IEEE 1394 standard bus to which HAVi compliant devices are connected, and the second network 3 is an IP network (for example according to the Ethernet protocol) to which UPnP standard compliant devices are connected. However, it is clear that other combinations of standards may be envisaged without departing from the framework of the present invention. As an example, the first and second network can both consists of IEEE 1394 network connecting HAVI compliant devices.

Here below in the description, the first and second networks 2, 3 are sometimes called a “HAVi network” and a “UPnP network” respectively.

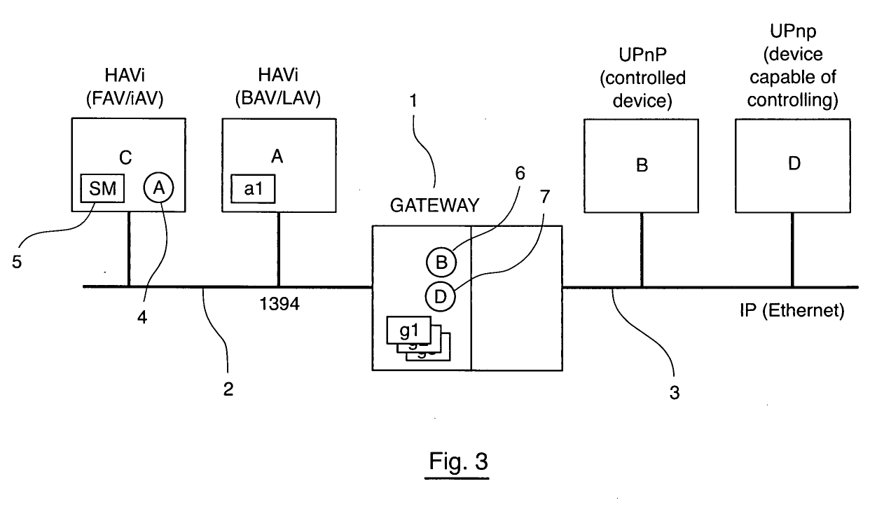

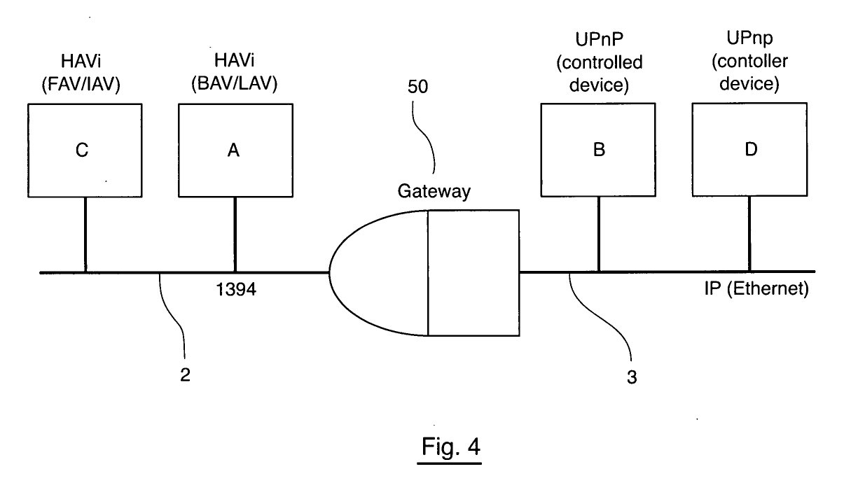

In the example shown in FIG. 4, it is assumed that the first and second networks (referenced 2 and 3), as well as the devices connected thereto (referenced A, B, C and D), are identical to those appearing in FIG. 3. For this reason, this FIG. 4 is not described in detail herein. Furthermore, the same elements keep the same references in FIGS. 3 and 4. However, the gateway according to the invention is referenced 50 in FIG. 4 while the prior art gateway is referenced 1 in FIG. 3.

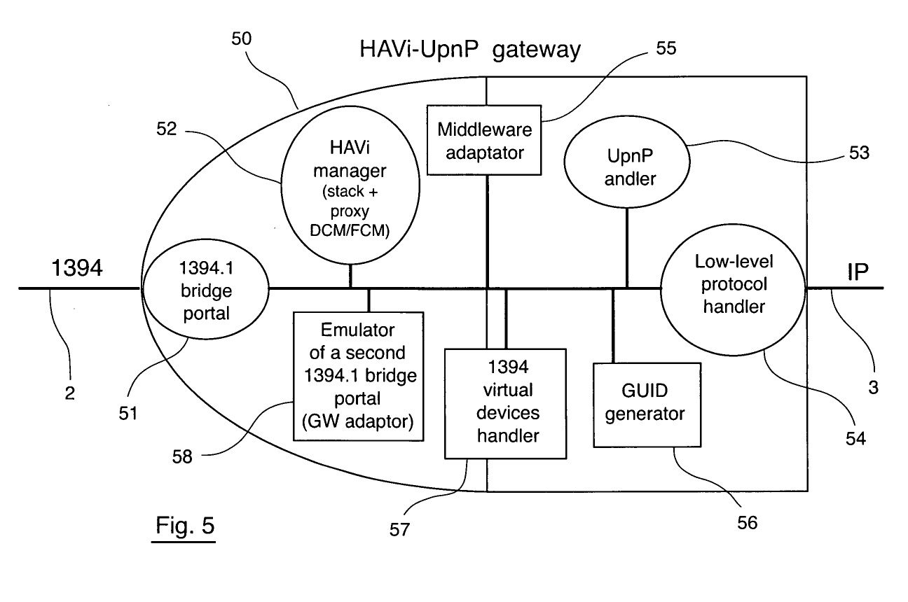

In a particular embodiment, illustrated in FIG. 5, the software architecture of the gateway 50 according to the invention comprises the following software modules:
a first 1394.1 bridge portal on the HAVi network side, referenced 51;
a HAVi handler or manager referenced 52;
a UPnP handler referenced 53;
a low-level protocol handler referenced 54;
an intermediate software layer adaptor or middleware adaptor referenced 55;
a GUID generator referenced 56;
a 1394 virtual devices handler referenced 57;
a GW adaptor or emulator of a second 1394.1 bridge portal on the UpnP network side, referenced 58.

Each of these software modules shall now be described more precisely.

The module 51 forming the first 1394.1 bridge portal on the HAVi network side possesses the functions described in the 1394.1 standard (see above-mentioned reference document) relating to the bridges between IEEE 1394 buses. This module 51 is also responsible for the 1394 functions of the physical (“PHY”), LINK and transaction (“TRAN”) levels.

The module 52 forming the HAVi handler 52 includes the HAVi software stack. This stack comprises at least the software modules required in the case of an IAV type HAVi device as well as certain of the optional software modules such as the isochronous stream manager (SM) and the DCM manager (DM)).

This module 52 is also responsible for the implementation of the (SE) HAVi DCM/FCM software elements representing the devices located on the second UPnP network. These are then referred to as proxy DCMs or proxy FCMs:
when a device is added/eliminated at the second network, the UPnP handler 53 detects it and provides a piece of information to the HAVi handler 52, by means of the intermediate software layer or middleware adaptor 55. The HAVi handler 52 is responsible for instantiating or eliminating the corresponding proxy DCM or proxy FCM components;
when a HAVi message received from the HAVi network is intended for a device of the UPnP network, it is up to the proxy DCM/FCM in question to analyze it and, as the case may be, to send it to said equipment on the second network, in using especially the services of the middleware adaptor 55 and the UPnP handler 53;
when a message is received by the UPnP handler 53, it is sent to the middleware adaptor 55, which is responsible for acting or not acting upon the HAVi handler 52 to generate possible action with the corresponding proxy DCM/FCM or other HAVi modules such as the event manager (EM)), in the case of the propagation of an event, or the HAVi components manager (Registry) in the case of the updating of data pertaining to the proxy DCM/FCM of a given device.

The module 53 forming a UPnP handler is responsible, at least, for the functions required in any UpnP device.

The module 54 forming a low-level protocol handler is responsible for implementing the communications protocols at the second network. For example, in the case of UPnP, it is responsible for adapting the IP/TCP/UDP protocols as a function of the low-level transmission (for example Ethernet) protocols and of the physical medium (for example, the coaxial cable or unshielded twisted pair (UTP)) used.

The module 55 forming a middleware adaptor is responsible for the processing operations relating to the adaptations between the HAVi architecture and the UPnP architecture:
the discovery/elimination of devices (information on the topology of the sub-networks);
the management/correspondence of the addressing (SEID for HAVi, IP/URL for UPnP);
the transfer of messages: adaptation (mapping) of the commands: “HAVi API call <-> UPnP service action call”;
the transfer of events: adaptation (mapping) of the events: “HAVi API call <-> UPnP event call”;
the positioning of a request for setting up an isochronous stream: adaptation between the HAVi commands (SM API, DCM/FCM API) and the UPnP services (AVTransport, ConnectionManager).

The module 56 forming the GUID generator is responsible for generating GUID identifiers coherent to the first HAVI network (which may also be constituted by several other networks of the 1394 bus type for example) for each of the devices located on the second network.

It may be recalled that a GUID identifier of a device consists of two fields: a first 24-bit field identifying the vendor/company of the device (this identifier is assigned by an official world organization (the “1394 Registration Authority Committee”) and a second 40-bit field (or serial number) identifying the device in a specific and unique way to the vendor/company.

According to the invention, the vendor/company identifier consists of a not assigned vendor/company identifier (for example it can be a reserved value or a not yet assigned value), which could be dedicated to this type of the gateway. A unique value is assigned to the second field or serial number. To the extent possible, a GUID that remains invariant in time is used. For example, the value assigned to the serial number may be generated from the Ethernet address of the device or its IP address, inasmuch as it remains fixed in time. The advantage over the prior art technique is that, since the GUID identifier is not linked to the gateway, a same GUID identifier is assigned to a given device, even when located behind another gateway (of the same type as that described in the present invention). The 1394 virtual devices handler 57 is responsible for creating and managing all the information on 1394 type devices, for each of the devices located on the second network (UPnP network) and presented as being of the 1394 type on the HAVi network side. This is information usually registered in the IEEE 1394 device configuration ROM (IEEE 1212 Configuration ROM), as well as information pertaining to HAVi functions (type of device, information used during the loading of the DCMs, etc.). In HAVi terms, all this information is called HAVi self-describing device data (SDD).

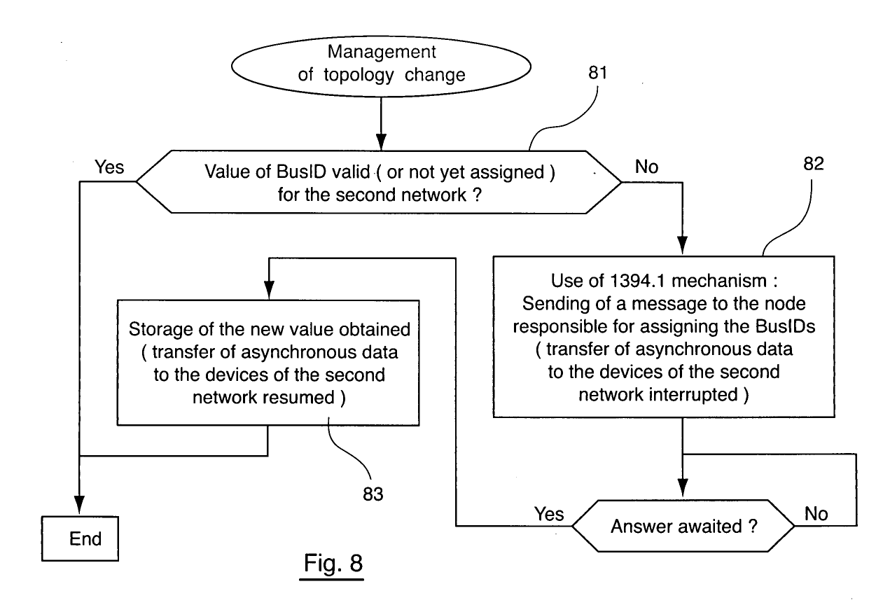

Furthermore, this module 57 is also responsible for assigning a 1394 type address to each of the devices physically located on the second network. The address comprises a 10-bit bus identifier (busID) and a 6-bit node identifier (nodeID). The value of busID is obtained by the emulator of a second bridge portal 1394.1 (or GW Adaptor module) using the mechanisms described in the 1394.1 standard. Reference may be made to FIG. 8 and to the corresponding description. To put it briefly, what the gateway does is to interpret the information on topology change exchanged between the portals (of the 1394.1 bridges) and detect whether the value of busID is still valid or not. In the event of non-validity, the gateway (HAVi portal side) will then use the 1394.1 mechanism making it possible to have a new value of busID that is valid. The portal called the “alpha-portal” asks the portal called the “prime portal”, responsible for the distribution of the values of busID, to assign it a valid bus value.

As those skilled in the art will appreciate, to set up a communication with a second device in the second network (through its associated virtual device), a first device needs to retrieve the 1394 address assigned by the gateway to the virtual device of the second device. The first device can retrieve the assigned 1394 address by using a Discovery and Enumeration Protocol, (as an example, such protocol can be found in Annex D of the IEEE 1394.1 standard). This protocol allows the first device to broadcast a request message in all networks to retrieve the 1394 address associated to a given GUID. The gateway will respond on behalf of the second device with the assigned 1394 address.

The “GW adaptor” module 58 is responsible for emulating the behavior of the second 1394.1 bridge portal on the UPnP network side, whether this relates to the 1394.1 inter-bridge messages or to the transfer of the 1394 asynchronous and isochronous packets.

In particular, when the emulator of the second bridge portal 1394.1 (GW Adaptor module) 58 receives a packet intended to be routed to a virtualized UPnP device (hence located on the second network) and when the memory address corresponds to an IEC 61883 register for the virtual device, then the packet is processed at the gateway. The information is stored in a data structure (forming a virtual register) managed by the 1394 virtual device handler for this UpnP device. Should it be necessary to act on the UpnP equipment, a message is generated, using the services of the middleware adaptor module 55 and of the UPnP handler module 53. Finally, a response must be returned, by the emulator of the second 1394.1 bridge portal (the “GW adaptor module) 58, to the initiator of the request.

Thus, each UpnP device located on the second network is virtualized at the 1394 level, and is therefore presented as being of the 1394 type on the first HAVi network (with a unique 1394 address at a given point in time and a GUID identifier that is invariant in time).

In accordance with the HAVi architecture, it is possible to show a device, on the HAVi network side, that is capable of managing the isochronous data stream and is located on the second network as being of the IEC61883 type (adequate updating of the “ROM configuration”). Thus, since each device located on the second identifier has a unique GUID identifier, the concepts of the HUID and the TargetID of the HAVi architecture remain valid.

One advantage of the virtualization, at the 1394 level, of each device located on the second network is that the IEC 61883 registers do not have to be physically located on the gateway but are supposed to be on said device (which is virtualized here). This removes the limit of 31 possible IEC 61883 registers at input (iPCR) and 31 other IEC 61883 registers at output (OPCR) authorized for a 1394 device such as the gateway. According to the invention, these registers are virtual and are henceforth managed by software means at the emulator of the second 1394.1 bridge portal (or GW adaptor module) 58.

The fact of not physically implementing the IEC 61883 registers on the gateway has the other advantage of not entailing any unnecessary consumption of bandwidth. Let us again take up the above-mentioned problem of the setting up of an isochronous data stream by a device C located on the first network between two devices B and D located on the second network. In the case of the invention, since the devices B and D are virtualized as understood in the 1394 standard, the IEC 61883 registers concerned (namely the register iPCR of the stream-receiving device B and the register oPCR of the stream-sending device D) are located at the level of this virtual bus and, hence, no disturbance is expected at the first network.

The setting up of the isochronous data stream (initiated by a specific HAVi software module (SM)) is furthermore compliant with the P1394.1 standard (“Controller-Talker-Listener mechanism”).

It will be noted that the gateway of the invention has a number of special features with respect to a 1394 bridge:
with respect to the functions of the first portal, which are executed at the module referenced 51: the routing table must be such that there is at most only one existing input (the one corresponding to the busID assigned to the second network); this gateway must be seen as a 1394 bridge (same interface) forming a leaf and not an intermediate device;
with respect to the functions of the second portal (co-portal) and of the portal of portals logically situated on the second network, which are executed at the level of the modules referenced 58 (GW Adaptor): all the inter-bridge messages must be analyzed and, if necessary, responses generated (also on behalf of the portal or portals in charge of the bus (second network) virtualized herein).

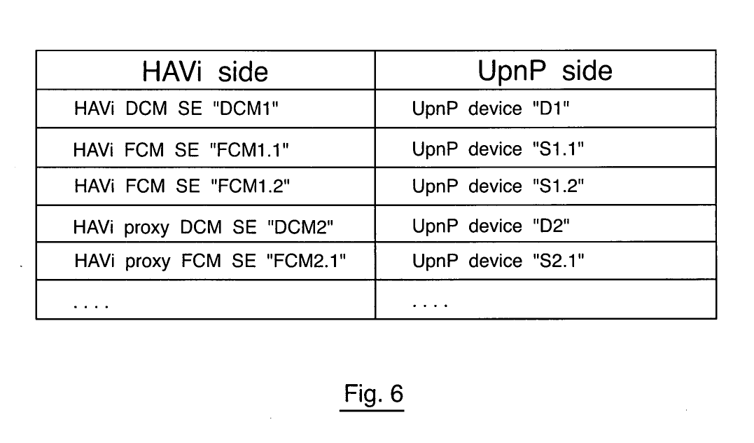

FIG. 6 describes an example of a table of correspondence between the HAVi elements on the one hand and the UPnP elements on the other hand.

In this example, it is assumed that, on the HAVi network side, following the detection of a new 1394 device on the 1394 bus, HAVi (DCM/FCMs) software components are instantiated:
a DCM software component “DCM1” has a UPnP device “D1” (description XML, type “device”) made to correspond to it;
each if its FCM software components, “FCM1.1, FCM1.2”, has the UPnP services <<S1.1, S1.2>> made to correspond to it (description XML, type “service”).

Similarly, in this example, it is assumed that, following the detection of a new UPnP device on the second network:
this UPnP device “D2” has a DCM software component “DCM2” (proxy DCM) made to correspond to it;
each of the services associated with this UPnP device “S2.1” has an FCM software component <<FCM2.1>> (proxy FCM) made to correspond to it.

It may be recalled that the HAVi standard specifies different types of FCM software elements (Tuner, VCR, clock, Camera, . . . ). The UPnP Forum also specifies different devices and associated services (Internet Gateway Device (IGD), Printer, Media Server, Media Renderer). Depending on the types of equipment defined in each of these standards, correspondence values may be pre-established. It is possible to have an updating of the correspondence between devices in order to ensure the different developments of devices: new services for devices, new devices etc.

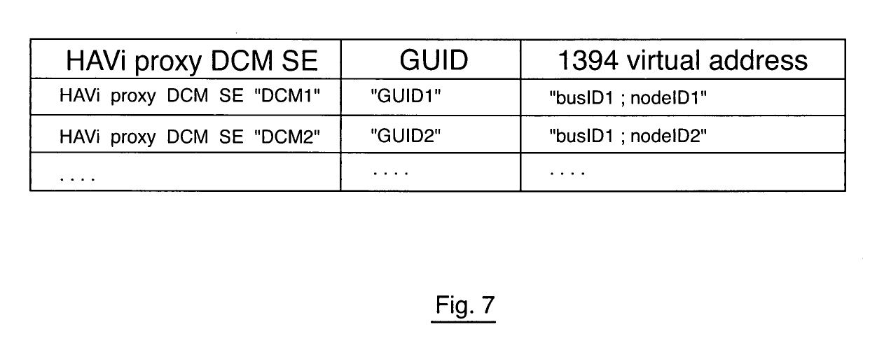

FIG. 7 describes an example of GUID Identifiers and 1394 virtual addresses assignment to UPnP devices emulated on the HAVi network side.

When an UPnP device is detected on the second network, the middleware adaptor module 55 is alerted through the UPnP handler module 53. If this UPnP device is unknown to the middleware adaptor module 55, this module 55 asks the GUID generator module 56 to give it a GUID identifier (for example “GUIDI”) for this new UpnP device. The middleware adaptor module 55 gathers together the information on this UPnP device and then asks the 1394 virtual device handler 57 to provide a 1394 virtual address (for example “busID1; nodeID1”) and build the associated 1394-HAVi (SDD) description. Finally, depending on the type of UpnP device, the middleware adaptor module 55 asks the HAVi handler module 52 to instantiate the appropriate DCM/FCMs (for example “HAVi DCM proxy SE DCM1”) (see HAVi 1.1 for the different DCMs/FCMs defined to date).

FIG. 8 describes the operations performed at GW Adaptor 58 when a topology change has been detected at the first network and is such that the value used of the busID of the virtual bus is no longer valid (for example when it is a conflicting value following the meeting of several 1394 buses), or again during the first assignment of the “busID” value of the virtual bus.

When one of the two case mentioned here above occurs (i.e. a positive response to the question of the step referenced 81), there is a passage to the step referenced 82. In this step, the GW Adaptor module 58 uses the mechanism described in P1394.1. In this mechanism, a new busID value is asked of a particular node (prime portal) responsible precisely for assigning the values of busID. After reception, the new value of busID is stored (step referenced 83).

It must be noted that so long as the value of “bus ID” remains invalid, the asynchronous communications between the first network and the second network are interrupted. These communications may be resumed after the new assignment of the value of the “bus ID” provided that the transmitters have obtained knowledge thereof (according to the mechanisms described in the 1394.1 standard).

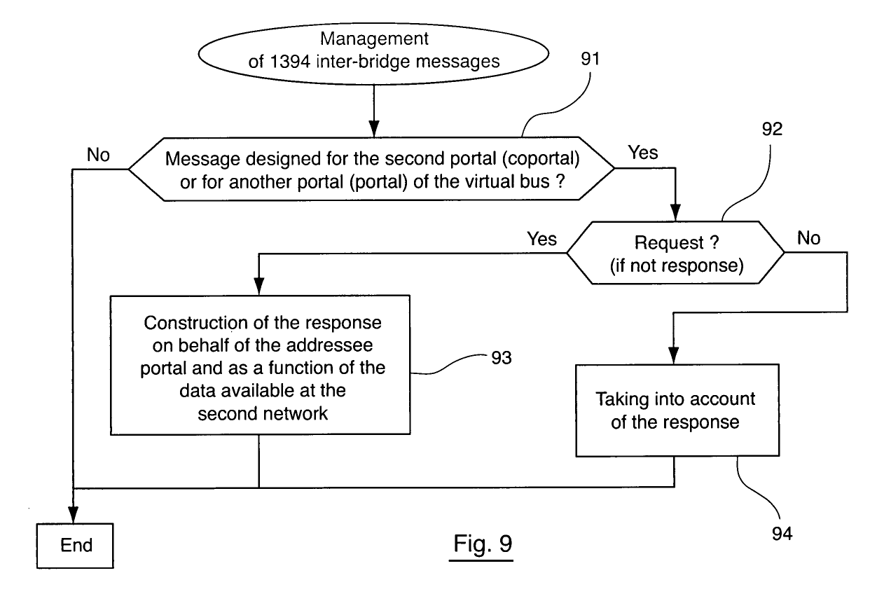

FIG. 9 describes the operations performed at the GW Adaptor module of a second 1394.1 bridge portal 58, when an inter-bridge message 1394.1 is received and is intended either for the second portal (co-portal) implemented at the gateway, or for a virtual portal supposed to be located on the second network (following the virtualization performed from the viewpoint of the first network).

When one of the two cases mentioned here above occurs (namely when there is a positive response to the question of the step referenced 9191), the operation passes to the step referenced 82, during which it is determined that the message received is a request or a response.

If it is a request, a response is generated on behalf of the initial addressee portal (which, in this case, becomes the source of the response), according to information available at the devices virtualized as understood according to the document 1394 of the second network (step referenced 93).

If this is a response to a previous request sent out by the second portal (co-portal) (this is the case when there is a request for a value of “busID” as described here above), then this response is taken into account (step referenced 94).

The presently disclosed embodiment is to be considered as illustrative and not restrictive. As those skilled in the art will appreciate, the invention can be applied in the context where both networks consists of IEEE 1394 networks, to which HAVI compliant devices are connected. In such context, the gateway comprises, in a known manner, a second 1394.1 bridge portal for the connection of the second network to the gateway. Such a bridge portal replaces the GW emulator 58. Similarly, the UPnP handler referenced 53 is replaced by a HAVI handler identical to the HAVI handler 52. Furthermore, the generation of GUID identifiers by the GW adaptor module 56 may simply consist of directly assigning the existing GUID identifier of a HAVI device, connected to the second network, to its associated virtual device.

1. A method of interconnection, through a gateway, between a first network of type IEEE 1394 enabling communications between a plurality of HAVi compliant devices and a second network enabling communications between a plurality of devices comprising the steps of:
determining a global unique identifier for each device from the second network;
determining a distinct IEEE 1394 address for each device from the second network;
representing each device from the second network by a HAVI compliant software element hosted by the gateway;
managing communication between devices from the first network and devices from the second network, using for each device from the second network, its corresponding software element associated with the global unique identifier and the IEEE1394 address.

2. A method according to claim 1, wherein the second network enables communications between a plurality of UPnP compliant devices.

3. A method according to claim 2, wherein the step of determining a global unique identifier comprises the step of generating a global unique identifier.

4. A method according to claim 2, wherein the step of determining a IEEE 1394 address for each device from the second network comprises a further step of generating a virtual IEEE 1394 address.

5. A method according to claim 4, wherein the step of generating a virtual IEEE 1394 address comprises a step of generating a bus identifier, representing the second network, according to the standard IEEE 1394.1.

6. A method according to claim 2, wherein the step of managing communication between devices from the first network and devices from the second network comprises the step of forming a bridge between a first bridge portal connected to the first network and an emulated second bridge portal and the step of managing communication between the emulated second bridge portal and the devices from the second network.

7. A method according to claim 1, wherein the second network enables communications between a plurality of HAVi compliant devices.

8. A method according to claim 7, wherein the step of determining a global unique identifier comprises the step of retrieving the global unique identifier of the corresponding HAVI device from the second network.

9. A method according to claim 7, wherein the step of determining a IEEE1394 address comprises the step of retrieving the IEEE1394 address of the corresponding HAVi device from the second network.

10. A method according to claim 7, wherein the step of managing communication between devices from the first network and devices from the second network comprises the step of forming a bridge compliant with the IEEE1394.1 standard between a first bridge portal connected to the first network and a second bridge portal connected to the second network.

11. A method according to claim 1, wherein the step of managing communication between a first device from the first network and a second device from the second network includes a step of retrieving, by the first device, the IEEE 1394 address associated to the second device using a discovery and enumeration protocol.

12. A method according to claim 1, which includes a further step of managing virtual registers compliant with IEC61883 specification associated with each device from the second network.

13. A method of interconnection, through a gateway, between a first serial bus network enabling transmission of audiovisual data enabling communications between a plurality of devices, compliant with a first standard of interoperability between devices connected to a serial bus network adapted for audiovisual data transmission, and a second network enabling communications between a plurality of devices comprising the steps of:
determining a global unique identifier for each device from the second network;
determining a distinct address compliant with the first serial bus network for each device from the second network;
representing each device from the second network by a software element, providing an interface for controlling functions of the device, in conformity with the first standard of interoperability, the software element being hosted by the gateway;
managing communication between devices from the first network and devices from the second network, using for each device from the second network, its corresponding software element associated with its global unique identifier and its address.

14. A gateway enabling the interconnection of a first network of type IEEE 1394 enabling communications between a plurality of HAVi compliant devices and a second network enabling communications between a plurality of devices, wherein the gateway comprises:
means to determine a global unique identifier for each device from the second network;
means to determine a distinct IEEE 1394 address for each device from the second network;
means to represent each device from the second network by a HAVI compliant software element hosted by the gateway;
means to manage communication between devices from the first network and devices from the second network, using for each device from the second network, its corresponding software element associated with the global unique identifier and the IEEE1394 address.

15. A gateway according to claim 14, wherein the second network enables communications between a plurality of UPnP compliant devices.

16. A gateway according to claim 15, wherein the means to determine a global unique identifier comprise means to generate a global unique identifier.

17. A gateway according to claim 15, wherein the means to determine a IEEE 1394 address for each device from the second network comprises a further step of generating a virtual IEEE 1394 address.

18. A gateway according to claim 17, wherein the step of generating a virtual IEEE 1394 address comprise means to generate a bus identifier, representing the second network, according to the standard IEEE 1394.1.

19. A gateway according to claim 15, wherein the means to manage communication between devices from the first network and devices from the second network comprises means to form a bridge between a first bridge portal connected to the first network and an emulated second bridge portal, and means to manage communication between the emulated second bridge portal and the devices from the second network.

20. A gateway according to claim 14, wherein the second network enables communications between a plurality of HAVi compliant devices.

21. A gateway according to claim 20, wherein the means to determine a global unique identifier comprise means to retrieve the global unique identifier of the corresponding HAVI device from the second network.

22. A gateway according to claim 20, wherein the means to determine a IEEE1394 address comprise means to retrieve the IEEE1394 address of the corresponding HAVi device from the second network.

23. A gateway according to claim 20, wherein the means to manage communication between devices from the first network and devices from the second network comprise means to form a bridge compliant with the IEEE1394.1 standard between a first bridge portal connected to the first network and a second bridge portal connected to the second network.

24. A gateway according to claim 14, wherein the means to manage communication between a first device from the first network and a second device from the second network comprise, in the first device, means to retrieve the IEEE 1394 address associated to the second device using a discovery and enumeration protocol.

25. A gateway according to claim 14, which comprises further means to manage virtual registers compliant with IEC61883 specification associated with each device from the second network.

26. A gateway enabling the interconnection of a first serial bus network enabling transmission of audiovisual data enabling communications between a plurality of devices, compliant with a first standard of interoperability between devices connected to a serial bus network adapted for audiovisual data transmission, and a second network enabling communications between a plurality of devices, wherein the gateway comprises:
means to determine a global unique identifier for each device from the second network;
means to determine a distinct address compliant with the first serial bus network for each device from the second network;
means to represent each device from the second network by a software element, providing an interface for controlling functions of the device, in conformity with the first standard of interoperability, the software element being hosted by the gateway;
means to manage communication between devices from the first network and devices from the second network, using for each device from the second network, its corresponding software element associated with its global unique identifier and its address.

27. A computer program product comprising instruction sequences adapted to the implementation of a method according to any of the claims 1 to 13, when said program is executed on a computer.
